(19) United States
(12) Patent Application Publication
(10) Pub. No.: US 2016/0202075 A1
(43) Pub. Date: Jul. 14, 2016

(54) TRAVEL TIME AND ROUTING

(71) Applicant: Hewlett Packard Enterprise Development LP, Houston, TX (US)

(72) Inventors: Lian LIU, Palo Alto, CA (US); Chetan Kumar GUPTA, San Mateo, CA (US); Krishnamurthy VISWANATHAN, Mountain, CA (US)

(21) Appl. No.: 14/913,742

(22) PCT Filed: Aug. 27, 2013
(86) PCT No.: PCT/US2013/056722

§ 371 Date: Feb. 23, 2016

(51) Int. Cl. G01C 21/34

(52) U.S. Cl. CPC G01C 21/34

(57) ABSTRACT

Disclosed herein are a system, non-transitory computer readable medium, and method to handle a routing problem. It is determined whether a fastest route can be resolved using static routing or time dependent routing.

### BACKGROUND

Navigation systems heretofore may be used to guide a traveler to a particular destination. Some navigation systems may use static routing to determine the fastest route. Static routing strategies may assume that each road has a constant speed (e.g., the speed limit). The recent availability of traffic information has given rise to time dependent routing strategies. Such strategies account for traffic when calculating the fastest route.

### BRIEF DESCRIPTION OF THE DRAWINGS

FIG. 1 is a block diagram of an example computing device in accordance with aspects of the present disclosure.

FIG. 2 is a flowchart of an example method for generating a route in accordance with aspects of the present disclosure.

FIG. 3 is a working example of route generation in accordance with aspects of the present disclosure.

FIG. 4 is a flowchart of an example method for calculating a travel time threshold in accordance with aspects of the present disclosure.

FIG. 5 is a working example of deriving a travel time threshold in accordance with aspects of the present disclosure.

FIG. 6 is an example graph of the working example in FIG. 5.

### DETAILED DESCRIPTION

As noted above, navigation systems may use static routing or time dependent routing to determine a fastest route. Given that travel speed can vary due to traffic, static routing may sometimes generate suboptimal routes. Time dependent routing techniques may use historical traffic data to determine the average travel speed of various routes to a destination. In turn, these average travel speeds may be used to calculate the fastest route. However, traffic can often be erratic and may deviate from historical traffic patterns. For example, unusual accidents may occur such that a seemingly optimal route based on historical data is now suboptimal in view of real time traffic information. Thus, due to the unpredictability of future traffic conditions, a fastest route may be difficult to determine in advance.

Fortunately, if the approximate travel time of a given route is relatively “short,” static routing, on average, produces the fastest or optimal route. If the approximate travel time of a given route is relatively “long,” time dependent routing, on average, produces the fastest route. However, determining when the approximate travel time is relatively “short” or relatively “long” may depend on several factors. Different cities or towns may have different travel time thresholds that can be used to distinguish between relatively “short” and relatively “long” routes.

Example implementations disclosed herein address the foregoing by providing a system, computer-readable medium, and method for handling routing problems. In one example, an approximate travel time between a first location and a destination may be determined in response to a request for a fastest route therebetween. In a further example, the approximate travel time may be compared to a predetermined travel time threshold to determine whether to use static routing or time dependent routing. In yet a further example, the predetermined travel time threshold may be determined by solving a plurality of random routing problems within a predetermined geographical radius. Thus, instead of using the static routing approach or the time dependent routing approach for every route request, the techniques disclosed herein may select one of the two approaches based on the approximate travel time of the route. As will be discussed in more detail below, the travel time threshold may be based on an analysis of random static and time dependent routes within a predetermined geographical radius. The aspects, features and advantages of the present disclosure will be appreciated when considered with reference to the following description of examples and accompanying figures. The following description does not limit the application; rather, the scope of the disclosure is defined by the appended claims and equivalents,

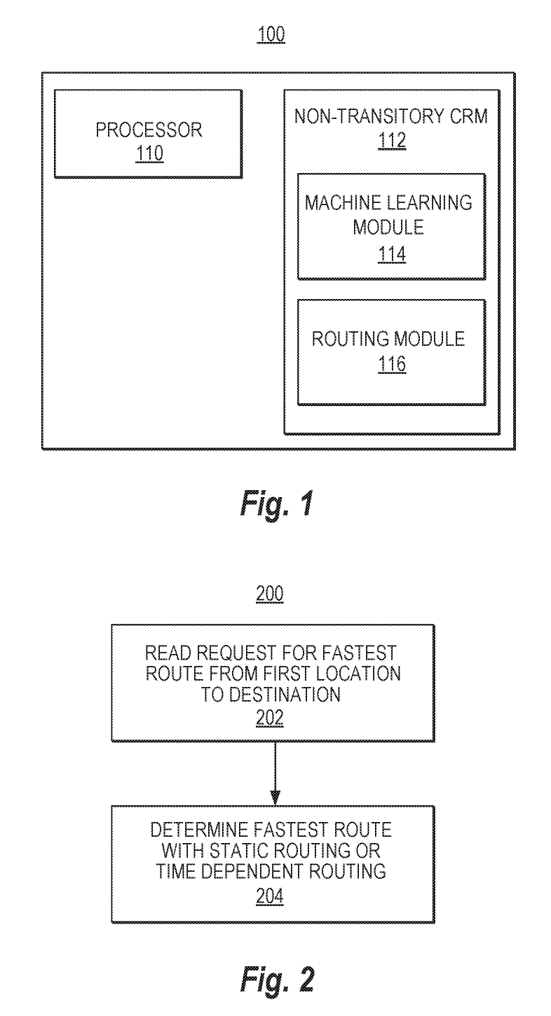

FIG. 1 presents a schematic diagram of an illustrative computer apparatus 100 for executing the techniques disclosed herein. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network.

The computer apparatus 100 may also contain at least one processor 110 which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a machine learning module 114 and a routing module 116. In one example, non-transitory CRM 112 may be used by or in connection with any instruction execution system that can fetch or obtain the logic from non-transitory CRM 112 and execute the instructions contained therein. While FIG. 1 shows machine learning module 114 and routing module 116 contained within the same computer apparatus 100, it is understood that machine learning module 114 and routing module 116 may execute on different computer apparatus.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. The non-transitory CRM 112 may also include any combination of one or more of the foregoing and/or other devices as well. While only one non-transitory CRM is shown in FIG. 1, computer apparatus 100 may actually comprise additional memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, routing module 116 may cause processor 110 to handle a request for a fastest route between a first location and at least one destination location and to obtain a travel time threshold predetermined by machine learning module 114. In a further example, routing module 116 may cause processor 110 to determine an approximate travel time between the first location and the at least one destination location. In yet a further example, routing module 116 may cause processor 110 to compare the travel time threshold to the approximate travel time to determine whether the fastest route can be resolved using a static routing approach or a time dependent routing approach. In another aspect, routing module 116 may cause processor 110 to use the static routing approach if the approximate travel time is less than the travel time threshold. In a further aspect, routing module 116 may cause processor 110 to use the time dependent routing approach if the approximate travel time is more than or equal to the travel time threshold.

In another example, machine learning module 114 may cause processor 110 to calculate the travel time threshold by solving a plurality of random routing problems within a predetermined geographical radius. In a further example, each random routing problem may be solved using the static routing approach and the time dependent routing approach. In yet a further example, machine learning module 114 may calculate the travel time threshold by causing processor 110 to determine an error adjusted static routing time for each random routing problem and an error adjusted time dependent routing time for each random routing problem. In another aspect, machine learning module 114 may cause processor 110 to determine whether a given error adjusted static routing time is substantially equivalent to a given error adjusted time dependent routing time. If so, machine learning module 114 may cause processor 110 to set the travel time threshold to be substantially equivalent to the given error adjusted static routing time or the given error adjusted time dependent routing time.

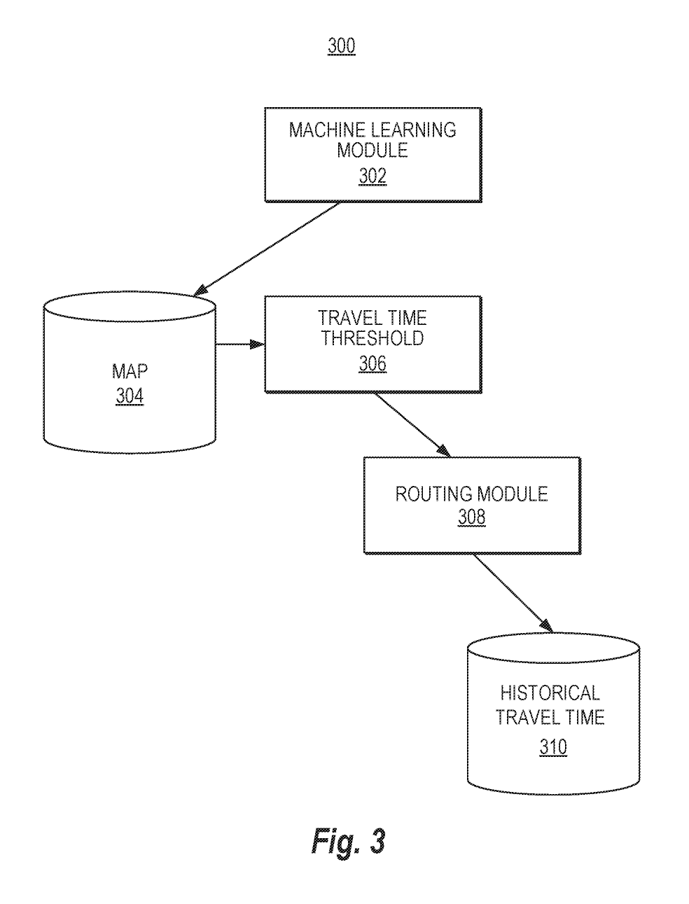

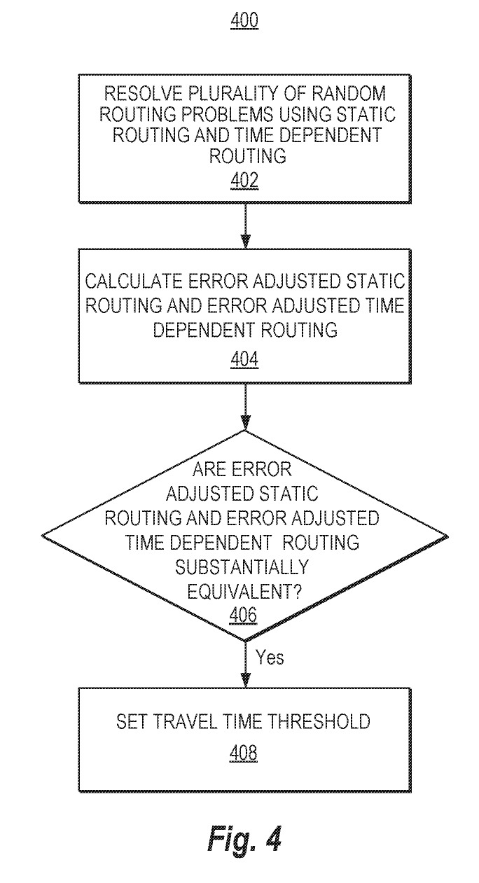

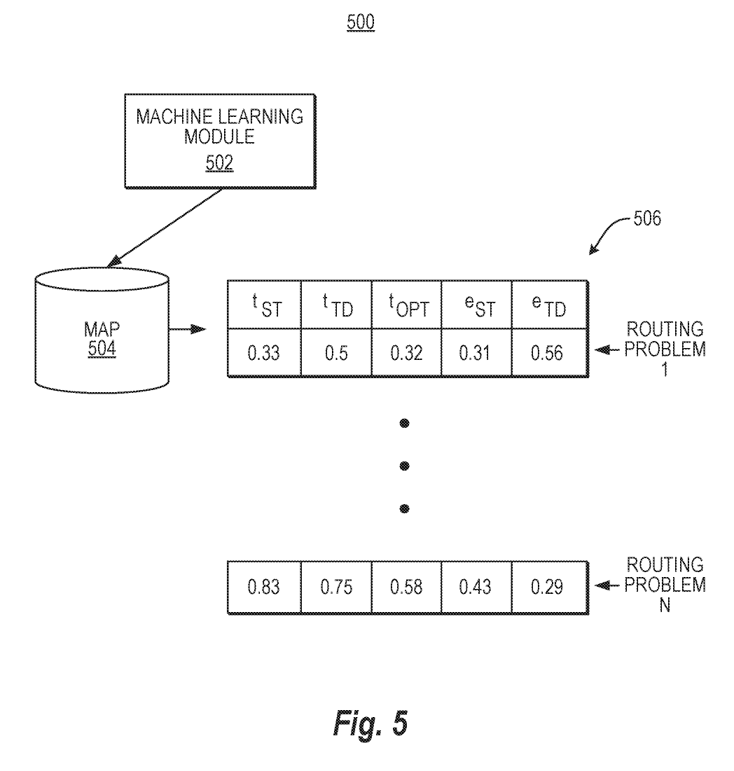

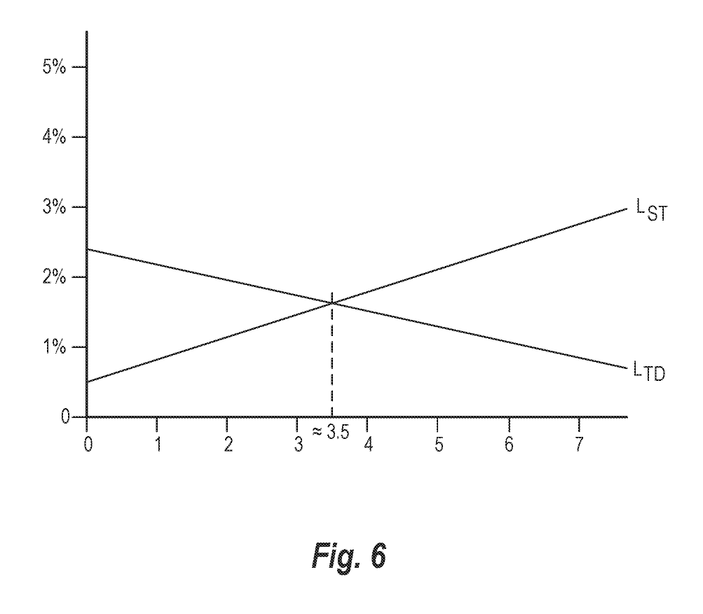

Working examples of the system, method, and non-transitory computer-readable medium are shown in FIGS. 2-6. In particular, FIG. 2 illustrates a flow diagram of an example method 200 for handling a routing problem and FIG. 3 is a working example of routing in accordance with the techniques herein. FIG. 4 is a flow diagram of an example method for determining a travel time threshold and FIGS. 5-6 show a working example in accordance with the travel time calculation techniques disclosed herein. The actions shown in FIG. 3 will be discussed with regard to the flow diagram of FIG. 2 and the actions shown in FIGS. 5-6 will be discussed below with regard to the flow diagram of FIG. 4.

Referring now to FIG. 2, a request for a fastest route from a first location to at least one destination may be read, as shown in block 202. Referring now to FIG. 3, routing module 308 is shown retrieving historical travel time information from historical travel time repository 310. This historical travel time may be used to determine an approximate travel time between the first location and at least one destination location. In one example, historical travel time repository 310 may be maintained by recording the travel time information of navigation system users. In this instance, historical travel time repository may be stored in, for example, a relational database as a table having a plurality of different fields and records, XML documents or even flat files. The historical travel time data may comprise any information sufficient to identify the relevant information, such as numbers, descriptive text, proprietary codes, or references to data stored in other network locations. Other network locations may include publicly available sources of historical travel time data. The historical travel time data in these publicly available sources may be recorded with road sensors. One example of publicly available historical travel time information is the California department of transportation website at http://pems.dot.ca.gov/.

Referring back to FIG. 2, the fastest route may be determined using static routing or time dependent routing, as shown in block 204. Referring back to FIG. 3, routing module 308 may obtain travel time threshold 306. Travel time threshold 306 may be predetermined by machine learning module 302. As will be explained in more detail below, travel time threshold 306 may be the threshold for a predetermined geographical radius. The data associated with the predetermined geographical radius may be obtained from map database 304. Map database 304 may be a publicly available map data base, such as the geocommunity website at data.geocomm.com. Travel time threshold 306 may be used to distinguish between a relatively “short” and relatively “long” travel time. In turn, routing module 308 may be able to determine whether the fastest route could be obtained with static routing or time dependent routing. As noted above, if the approximate travel time is less than travel time threshold 306, routing module 308 may use static routing to determine the fastest route. In another example, if the approximate travel time is greater than or equal to travel time threshold 306, routing module 308 may use time dependent routing to determine the fastest route.

Referring now to FIG. 4, an example method for determining a travel time threshold is shown. As shown in block 402, a plurality of random routing problems within a predetermined geographic radius may be resolved using static routing and time dependent routing. Studies have shown a correlation between the size of the geographic radius and the precision of the travel time threshold. In particular, studies have shown that the larger the radius the less accurate the travel time threshold. Thus, a balance must be found between the accuracy of the travel time threshold and the area covered by the navigation system. That is, a commercial navigation system may want to cover as broad a radius as possible with minimal degradation the threshold's precision. As noted above, each random routing problem within the predetermined geographic radius may be solved using static routing and time dependent routing, Each random routing problem may have a random route size, departure location, and destination location. Furthermore, each random routing problem may take place within some particular time frame in the past. As will be explained further below, traffic data recorded before and after the departure time of each random routing problem may be used to calculate the travel time threshold.

Referring back to FIG. 4, an error adjusted static routing time and an error adjusted time dependent routing time may be determined for each random routing problem, as shown in block 404. Referring now to FIG. 5, machine learning module 502 is shown resolving a plurality of random routing problems within a predetermined geographic radius using data from map database 504. The values produced for each random routing problem are shown stored in an example memory table 506. For each random routing problem 1 thru N a static routing time (t_{ST}) may be calculated. The static routing time may be that fastest routing time according to a static routing approach. Furthermore, for each random routing problem, a time dependent routing time (t_{TD}) may also be determined. The time dependent routing time may be the fastest routing time according to a time dependent routing approach using traffic information recorded before the departure time of each random routing problem. In one example, historical traffic data recorded within 6 months prior to the departure time of each random routing problem may be used. Moreover, an optimal travel time (t_{OPT}) may also be determined for each random routing problem. In one example, the optimal travel time may be the fastest routing time according to a time dependent routing approach using data recorded after the departure time of each random routing problem. In one example, traffic data recorded within 6 months after the departure time of each random routing problem may be used. Studies show that time dependent routing is most likely to produce the fastest or optimal route when it's based on accurate future data, It is understood that the traffic data recorded before and after the departure time of each random routing problem need not be equal in duration and that different time durations may be used (e.g., 4 months prior and 7 months after).

In one example, the static routing time (t_{ST}), the time dependent routing time (t_{TD}), and the optimal travel time (t_{OPT}) may be used to find an error adjusted static routing time (e_{ST}) for each routing problem 1 thru N such that:

e_{ST}=(t_{ST}−t_{OPT})/t_{OPT}

In a further example, an error adjusted time dependent routing time (e_{TD}) may be determined for each routing problem 1 thru N such that:

e_{TD}=(t_{TD}−t_{OPT})/t_{OPT}

Referring back to FIG. 4, it may be determined whether a given error adjusted static routing time is substantially equivalent to a given error adjusted time dependent routing time, as shown in block 406. If so, the travel time threshold may be set, as shown in block 408. Referring now to FIG. 6, a graph 600 is shown. FIG. 6 shows a line (L_{ST}) that represents each error adjusted static routing travel time plotted in a two dimensional graph. Furthermore, FIG. 6 also shows a line (L_{TD})) that represents each error adjusted time dependent routing travel time plotted in the two dimensional graph. The x-axis represents the travel time of each given random routing problem and the corresponding y-axis represents the percentage of error of each plotted travel time with respect to the optimal travel time. In this example, an error adjusted static travel time is substantially equivalent to an error adjusted time dependent travel time at approximately 3.5 hours. Thus, in this example, the travel time threshold may be set to 3.5 hours such that an approximate travel time less than 3.5 hours may be deemed a short travel time and an approximate travel time greater than or equal to 3.5 hours may be deemed a long travel time.

Advantageously, the foregoing system, method, and non-transitory computer readable medium may attempt to calculate a fastest route using static routing or time dependent routing. The decision to use either approach may be based on a comparison of the approximate travel time of the routing problem and a predetermined travel time threshold. In this regard, the threshold may be predetermined by executing both static and time dependent routing for a plurality of random routing problems within some geographic radius, In turn, the techniques disclosed herein may have a higher likelihood of producing the fastest route than conventional techniques.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a storage comprising a machine learning module;
a routing module which upon execution causes at least one processor to
handle a request for a fastest route between a first location and at least one destination location;
obtain a travel time threshold predetermined by the machine learning module;
determine an approximate travel time between the first location and the at least one destination location; and
compare the travel time threshold to the approximate travel time to determine whether the fastest route can be resolved using a static routing approach or a time dependent routing approach.

2. The system of claim 1, wherein the routing module upon execution further causes at least one processor to use the static routing approach if the approximate travel time is less than the travel time threshold.

3. The system of claim 1, wherein the routing module upon execution further causes the at least one processor to use the time dependent routing approach if the approximate travel time is more than or equal to the travel time threshold.

4. The system of claim 1, wherein to calculate the travel time threshold the machine learning module upon execution further instructs at least one processor to solve a plurality of random routing problems within a predetermined geographic radius such that each random routing problem is solved using the static routing approach and the time dependent routing approach.

5. The system of claim 4, wherein to calculate the time threshold the machine learning module upon execution further instructs at least one processor to:
determine an error adjusted static routing time for each random routing problem; and
determine an error adjusted time dependent routing time for each random routing problem.

6. The system of claim 5, wherein to calculate the time threshold the machine learning module upon execution further instructs at least one processor to
determine whether a given error adjusted static routing time is substantially equivalent to a given error adjusted time dependent routing time; and
set the travel time threshold to be substantially equivalent to the given error adjusted static routing time or the given error adjusted time dependent routing time, if the given error adjusted static routing time is substantially equivalent to the given error adjusted time dependent routing time.

7. A non-transitory computer readable medium having instructions therein which upon execution cause at least one processor to:
handle a request to resolve a routing problem such that a solution thereto comprises a fastest route between a first location and at least one destination;
determine an approximate travel time between the first location and the at least one destination;
resolve the routing problem using static routing if the approximate travel time is less than a predetermined travel time threshold; and
resolve the routing problem using time dependent routing if the approximate travel time is greater than or equal to the predetermined travel time threshold.

8. The non-transitory computer readable medium of claim 7, wherein the instructions therein upon execution further cause at least one processor to calculate the travel time threshold by resolving a plurality of random routing problems within a predetermined geographic radius such that each random routing problem is solved using static routing and time dependent routing.

9. The non-transitory computer readable medium of claim 8, wherein the instructions therein upon execution further cause at least one processor to:
calculate an error adjusted static routing time for each random routing problem; and
calculate an error adjusted time dependent routing time for each random routing problem.

10. The non-transitory computer readable medium of claim 9 wherein the instructions therein upon execution further cause at least one processor to:
determine whether a given error adjusted static routing time is substantially equivalent to a given error adjusted time dependent routing time; and
set the travel time threshold to be substantially equivalent to the given error adjusted static routing time or the given error adjusted time dependent routing time, if the given error adjusted static routing time is substantially equivalent to the given error adjusted time dependent routing time.

11. A method comprising:
reading, using at least one processor, a request to resolve a fastest route between a first location and at least one other location;
determining, using at least one processor, an approximate travel time between the first location and the at least one other location; and
analyzing, using at least one processor, the approximate travel time to determine whether the fastest route can be resolved using static routing or time dependent routing.

12. The method of claim 11, further comprising
resolving, using at least one processor, the fastest route using static routing, if the approximate travel time is less than a predetermined travel time threshold; and
resolving, using at least one processor, the fastest route using time dependent routing, if the approximate travel time is greater than or equal to the predetermined travel time threshold.

13. The method of claim 12, wherein determining the travel time threshold comprises resolving, using at least one processor, a plurality of random routing problems within a predetermined geographic radius such that each random routing problem is solved using static routing and time dependent routing.

14. The method of claim 13, further comprising
calculating, using at least one processor, an error adjusted static routing time for each random routing problem; and
calculating, using at least one processor, an error adjusted time dependent routing time for each random routing problem.

15. The method of claim 14, further comprising
determining, using at least one processor, whether a given error adjusted static routing time is substantially equivalent to a given error adjusted time dependent routing time; and
setting, using at least one processor, the travel time threshold to be substantially equivalent to the given error adjusted static routing time or the given error adjusted time dependent routing time, if the given error adjusted static routing time is substantially equivalent to the given error adjusted time dependent routing time.
